(19) United States
(12) Patent Application Publication
(10) Pub. No.: US 2024/0312089 A1
(43) Pub. Date: Sep. 19, 2024

(54) INFORMATION PROCESSING SYSTEM, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Kenichi NUMATA, Kanagawa (JP)

(73) Assignee: FUJIFILM BUSINESS INNOVATION CORP., Tokyo (JP)

(21) Appl. No.: 18/452,817

(22) Filed: Aug. 21, 2023

(30) Foreign Application Priority Data
Mar. 15, 2023 (JP) 2023-040936

(51) Int. Cl. G06T 11/60; G06V 10/776; G06V 20/60; G06V 20/70; H04N 23/60

(52) U.S. Cl. CPC G06T 11/60; G06V 10/776; G06V 20/60; G06V 20/70; H04N 23/64; G09B 5/02

(57) ABSTRACT

An information processing system includes one or more processors configured to: from an image captured of a target object of a task and a worker performing the task, detect the target object and a change in a state of the target object; and correlate information about the detected change in the state of the target object with information about a pre-created procedure of the task.

### CROSS-REFERENCE TO RELATED APPLICATIONS

This application is based on and claims priority under 35 USC 119 from Japanese Patent Application No. 2023-040936 filed Mar. 15, 2023.

### BACKGROUND

### (i) Technical Field

The present disclosure relates to an information processing system, a non-transitory computer readable medium, and an information processing method.

### (ii) Related Art

A technique is known for creating a task manual for moving images by correlating a combination of an operator's movement and a target object of a task, which are detected from a moving image captured of how the task is done, with the content of a pre-created task procedure (see, for example, Japanese Patent No. 7023427).

In such a technique, by detecting a combination of an operator's movement and a target object of a task, it is possible to correlate the combination with a pre-created task procedure. However, because human movements are complex, it is difficult to detect every movement of the operator.

### SUMMARY

Aspects of non-limiting embodiments of the present disclosure relate to creating a task manual for moving images without detecting an operator's movement from an image captured of how the task is done.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: from an image captured of a target object of a task and a worker performing the task, detect the target object and a change in a state of the target object; and correlate information about the detected change in the state of the target object with information about a pre-created procedure of the task.

### BRIEF DESCRIPTION OF THE DRAWINGS

Exemplary embodiments of the present disclosure will be described in detail based on the following figures, wherein:

FIG. 1 is a diagram illustrating an example of the overall configuration of an information processing system to which an exemplary embodiment is applied;

FIG. 2 is a diagram illustrating an example of the hardware configuration of a management server;

FIG. 3 is a diagram illustrating the hardware configuration of a user terminal;

FIG. 4 is a diagram illustrating an example of the functional configuration of a controller of the management server;

FIG. 5 is a diagram illustrating an example of the functional configuration of a controller of the user terminal;

FIG. 6 is a flowchart illustrating an example of the flow of processing in the management server;

FIG. 7 is a flowchart illustrating an example of the flow of processing executed when capturing an image of a target object, which is part of the processing in the user terminal;

FIGS. 8A and 8B are diagrams illustrating the configuration and content of “Work Procedure Manual” as a specific example of task procedure information, namely, FIG. 8A is a diagram illustrating an example of the configuration of “Work Procedure Manual”, and FIG. 8B is a diagram illustrating an example of the content of “Work Procedure Manual”;

FIG. 9 is a diagram illustrating a specific example of a target image;

FIGS. 10A to 10C are diagrams illustrating specific examples of, among frame images which are images No. 1 to No. 12 corresponding to frame images 1 to 12 illustrated in FIG. 9, the frame images which are images No. 1 to No. 3 and target object detection lists corresponding to the frame images, namely, FIG. 10A is a diagram illustrating a specific example of the frame image which is image No. 1 and a target object detection list corresponding to the frame image, FIG. 10B is a diagram illustrating a specific example of the frame image which is image No. 2 and a target object detection list corresponding to the frame image, and FIG. 10C is a diagram illustrating a specific example of the frame image which is image No. 3 and a target object detection list corresponding to the frame image;

FIGS. 11A to 11C are diagrams illustrating specific examples of, among the frame images which are images No. 1 to No. 12 illustrated in FIG. 9, the frame images which are images No. 4 to No. 6 and target object detection lists corresponding to the frame images, namely, FIG. 11A is a diagram illustrating a specific example of the frame image which is image No. 4 and a target object detection list corresponding to the frame image, FIG. 11B is a diagram illustrating a specific example of the frame image which is image No. 5 and a target object detection list corresponding to the frame image, and FIG. 11C is a diagram illustrating a specific example of the frame image which is image No. 6 and a target object detection list corresponding to the frame image;

FIGS. 12A and 12B are diagrams illustrating specific examples of, among the frame images which are images No. 1 to No. 12 illustrated in FIG. 9, the frame images which are images No. 7 and No. 8 and target object detection lists corresponding to the frame images, namely, FIG. 12A is a diagram illustrating a specific example of the frame image which is image No. 7 and a target object detection list corresponding to the frame image, and FIG. 12B is a diagram illustrating a specific example of the frame image which is image No. 8 and a target object detection list corresponding to the frame image;

FIGS. 13A and 13B are diagrams illustrating specific examples of, among the frame images which are images No. 1 to No. 12 illustrated in FIG. 9, the frame images which are images No. 9 and No. 10 and target object detection lists corresponding to the frame images, namely, FIG. 13A is a diagram illustrating a specific example of the frame image which is image No. 9 and a target object detection list corresponding to the frame image, and FIG. 13B is a diagram illustrating a specific example of the frame image which is image No. 10 and a target object detection list corresponding to the frame image;

FIGS. 14A and 14B are diagrams illustrating specific examples of, among the frame images which are images No. 1 to No. 12 illustrated in FIG. 9, the frame images which are images No. 11 and No. 12 and target object detection lists corresponding to the frame images, namely, FIG. 14A is a diagram illustrating a specific example of the frame image which is image No. 11 and a target object detection list corresponding to the frame image, and FIG. 14B is a diagram illustrating a specific example of the frame image which is image No. 12 and a target object detection list corresponding to the frame image;

FIGS. 15A and 15B are diagrams illustrating a specific example of a process of correlating a target object detection list with task procedure information, namely, FIG. 15A is a diagram illustrating a specific example of the content of “Work Procedure Manual” as task procedure information; and FIG. 15B is a diagram illustrating a specific example of a target object detection list;

FIGS. 16A and 16B are diagrams illustrating specific examples of a process of determining the validity of detection, namely, FIG. 16A is a diagram illustrating a specific example of false detection of a target object, and FIG. 16B is a diagram illustrating a specific example of missed detection of a target object;

FIG. 17 is a diagram illustrating a specific example of false detection of a change in the state of a target object;

FIG. 18A is a diagram illustrating a specific example of a user interface used for operation to modify a target object detection list, and FIG. 18B is a diagram illustrating a specific example of image capturing assist information displayed in an image capturing screen while capturing an image of a target object; and

FIGS. 19A and 19B are diagrams illustrating other specific examples of image capturing assist information displayed in the image capturing screen while capturing an image of a target object.

### DETAILED DESCRIPTION

Hereinafter, an exemplary embodiment of the present disclosure will be described in detail with reference to the accompanying drawings.

### Overall Configuration of Information Processing System

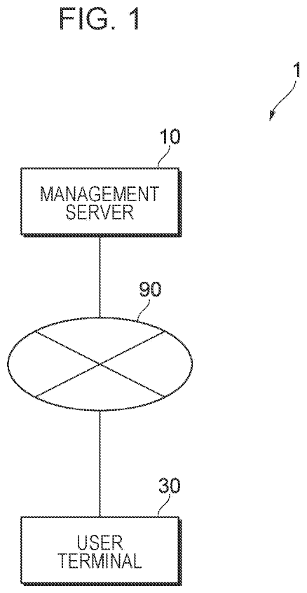

FIG. 1 is a diagram illustrating an example of the overall configuration of an information processing system 1 to which the present exemplary embodiment is applied.

The information processing system 1 is configured by connecting a management server 10 and a user terminal 30 via a network 90. The network 90 is, for example, a local area network (LAN), the Internet, or the like.

### Management Server

The management server 10 included in the information processing system 1 is an information processing apparatus as a server that manages the entire information processing system 1. The management server 10 performs a process of obtaining various types of information transmitted from the user terminal 30, various processes on the various types of information obtained, and a process of transmitting various types of information to the user terminal 30.

For example, the management server 10 obtains an image captured (hereinafter referred to as a “target image”) of an object on which a task is performed (hereinafter referred to as a “target object”), and an operator performing the task. The “target image” is composed of a moving image, that is, a plurality of still images having continuity (hereinafter may be referred to as “frame images”). The target image may be captured by the user terminal 30 or may be separately obtained from the outside or the like.

The management server 10 divides the obtained target image into a plurality of frame images in chronological order, and detects the target object in each of the frame images indicating the individual timings. The management server 10 then detects a change in the state of the target object based on the chronological order of the state of the target object, which is included in each of the frame images. Specifically, the management server 10 creates a list representing the chronological order of the state of the target object (hereinafter referred to as a “target object detection list”), and, based on the target object detection list, detects a change in the state of the target object.

The management server 10 stores information about a task procedure for the target object (hereinafter referred to as “task procedure information”) in a database, and manages it. The management server 10 correlates the task procedure information stored in the database with a change in the state of the target object. At that time, the management server 10 determines the validity of detection of a change in the state of the target object based on the result of comparing the task procedure information and the change in the state of the target object to see if the two are correlated, and modifies the target object detection list in accordance with the determination result.

In addition, the management server 10 performs control to display the task procedure information, which serves as annotation information to be superimposed on the target image, in a reproducing screen of the user terminal 30 which is reproducing the target image. At this time, the management server 10 determines the timing to display the task procedure information based on the correlation between the timing of the change in the state of the target object and the timing of the task.

In addition, the management server 10 performs control to display information for assisting the image capturing (hereinafter referred to as “image capturing assist information”) in an image capturing screen of the user terminal 30 which is capturing the target image. The image capturing assist information is displayed based on the correlation between a change in the target object detected in real time by the user terminal 30 capturing an image of the target object, and the pre-stored task procedure information. Note that the details of the configuration and processing in the management server 10 will be described later.

### User Terminal

The user terminal 30 is an information processing apparatus such as a smart phone, a tablet terminal, a head-mounted display (HMD), or the like, which is operated by a user who uses the information processing system 1. The user terminal 30 captures a target image based on a user operation. In addition, the user terminal 30 performs a process of obtaining various types of information transmitted from the management server 10, various processes on the various types of information obtained, and a process of transmitting various types of information to the management server 10. For example, based on control information from the management server 10, the user terminal 30 displays the target image as frame images or reproduces the target image as a moving image. Note that the details of the configuration and processing in the user terminal 30 will be described later.

The configuration of the above-described information processing system 1 is one example, and it is only necessary for the information processing system 1 to be equipped with, as a whole, functions for realizing the above-described processes. Therefore, some or all of the functions for realizing the above-described processes may be shared or cooperated within the information processing system 1. That is, some or all of the functions of the management server 10 may be the functions of the user terminal 30, and/or some or all of the functions of the user terminal 30 may be the functions of the management server 10. Moreover, some or all of the functions of each of the management server 10 and the user terminal 30 included in the information processing system 1 may be transferred to another server or the like (not illustrated) to perform some or all of the above-described processes. This promotes the processing in the information processing system 1 as a whole, and also enables the processing to be complemented.

### Hardware Configuration

### Hardware Configuration of Management Server

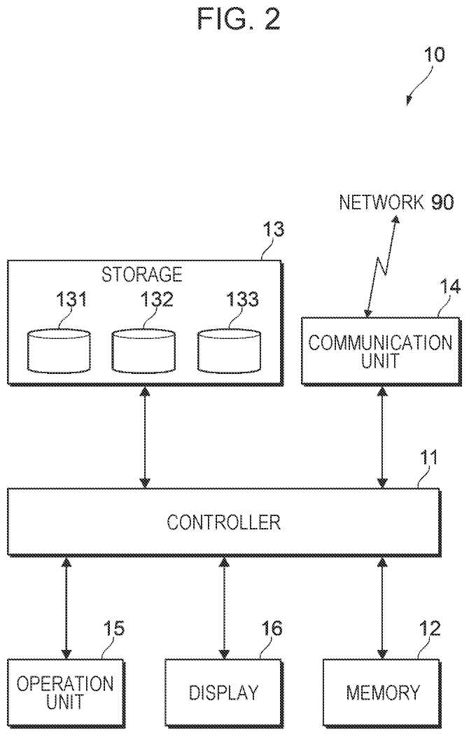

FIG. 2 is a diagram illustrating an example of the hardware configuration of the management server 10.

The management server 10 includes a controller 11, a memory 12, a storage 13, a communication unit 14, an operation unit 15, and a display 16. These units are connected by a data bus, an address, a peripheral component interconnect (PCI) bus, etc.

The controller 11 is a processor configured to control the functions of the management server 10 through execution of various types of software such as an operating system (OS), which is basic software, and application software. The controller 11 is composed of, for example, a central processing unit (CPU). The memory 12 is a storage area for storing various types of software and data used for executing the software, and is used as a work area during arithmetic processing. The memory 12 is composed of, for example, a random-access memory (RAM).

The storage 13 is a storage area for storing input data for various types of software and output data from various types of software. The storage 13 is composed of, for example, a hard disk drive (HDD) or a solid state drive (SSD) used for storing programs and various types of setting data, a semiconductor memory, or the like. Databases for storing various types of information are stored in the storage 13. As the databases stored in the storage 13, for example, a task procedure database (DB) 131, which stores task procedure information, a target image DB 132, which stores target images, and a state change DB 133, which stores target object detection lists, are stored.

The communication unit 14 performs data transmission and reception between the user terminal 30 and the outside via the network 90. The operation unit 15 is composed of, for example, a keyboard, a mouse, mechanical buttons, and a switch, and receives input operations. The operation unit 15 may include a touch sensor that configures a touchscreen integrally with the display 16. The display 16 is composed of, for example, a liquid crystal display or an organic electroluminescence (EL) display, and displays image (moving image and still image) data and text data.

### Hardware Configuration of User Terminal

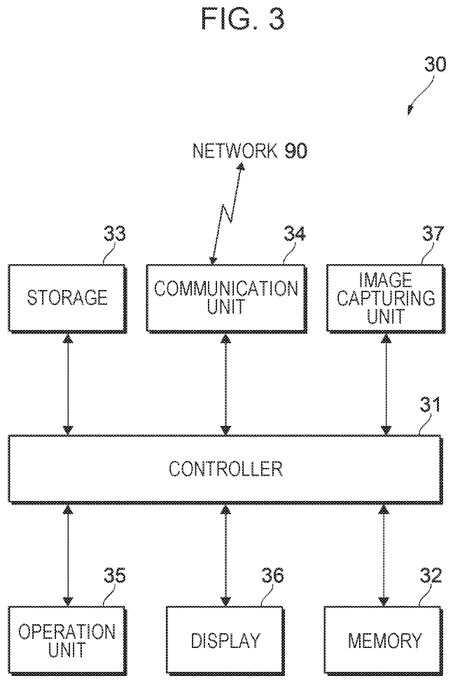

FIG. 3 is a diagram illustrating the hardware configuration of the user terminal 30.

The user terminal 30 includes a controller 31, a memory 32, a storage 33, a communication unit 34, an operation unit 35, and a display 36, which respectively correspond to the controller 11, the memory 12, the storage 13, the communication unit 14, the operation unit 15, and the display 16 of the management server 10 in FIG. 2, and, in addition to these configurations, the user terminal 30 includes an image capturing unit 37. The image capturing unit 37 is composed of a camera and the like, which captures images of a plurality of documents as subjects displayed on the display 36, which also functions as a viewfinder for the camera, and obtains the captured images as moving image data. These units are connected by a data bus, an address bus, a PCI bus, etc.

### Functional Configuration

### Management Server

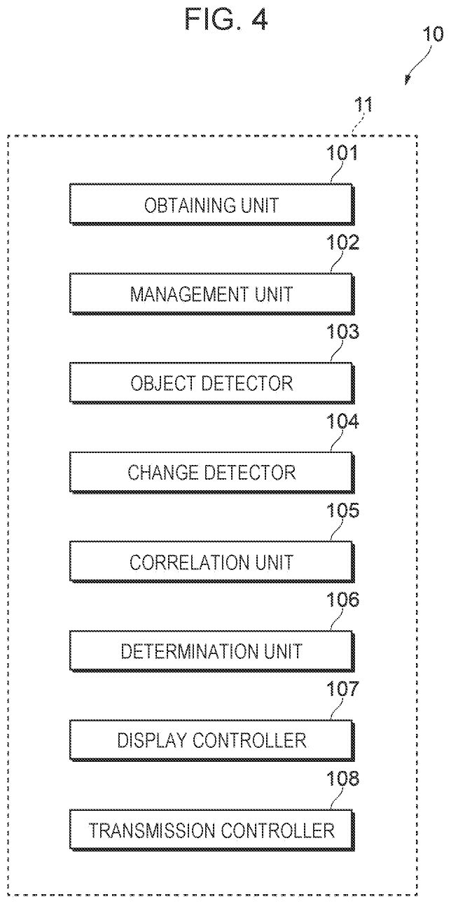

FIG. 4 is a diagram illustrating an example of the functional configuration of the controller 11 of the management server 10.

In the controller 11 of the management server 10, an obtaining unit 101, a management unit 102, an object detector 103, a change detector 104, a correlation unit 105, a determination unit 106, a display controller 107, and a transmission controller 108 function.

The obtaining unit 101 obtains various types of information. Specifically, the obtaining unit 101 obtains various types of information transmitted from each of the user terminal 30 and the outside. Of the information obtained by the obtaining unit 101, examples of information transmitted from the user terminal 30 include a target image captured by the user terminal 30 and input information input by a user operation.

The management unit 102 stores various types of information in the databases of the storage 13 (see FIG. 2) and manages them. For example, the management unit 102 stores task procedure information in the task procedure DB 131 and manages it. In addition, the management unit 102 stores a target image in the target image DB 132 and manages it. The management unit 102 further stores a target object detection list in the state change DB 133 and manages it. Work procedure information and a target object detection list are correlated by the later-described correlation unit 105.

The object detector 103 divides a target image into a plurality of frame images in chronological order, and detects a target object in each of the frame images. In doing so, the target object at each timing indicated by a corresponding one of the frame images is detected. Note that the method by which the object detector 103 detects an object is not particularly limited, and an object may be detected using a general image recognition technique. For example, a determination model may be created by machine learning the results of object detection.

The change detector 104 detects a change in the state of the target object, which is included in each of the frame images composing the target image, based on the chronological order of the state of the target object. Specifically, the change detector 104 creates a target object detection list, and detects a change in the state of the target object between two timings included in the target object detection list.

The correlation unit 105 correlates a change in the state of the target object detected by the change detector 104 with the task procedure information stored in the task procedure DB 131. Specifically, the correlation unit 105 correlates the timing of the change in the state of the target object, which is identified from the target object detection list, with the timing of the task, which is identified from the pre-stored task procedure information.

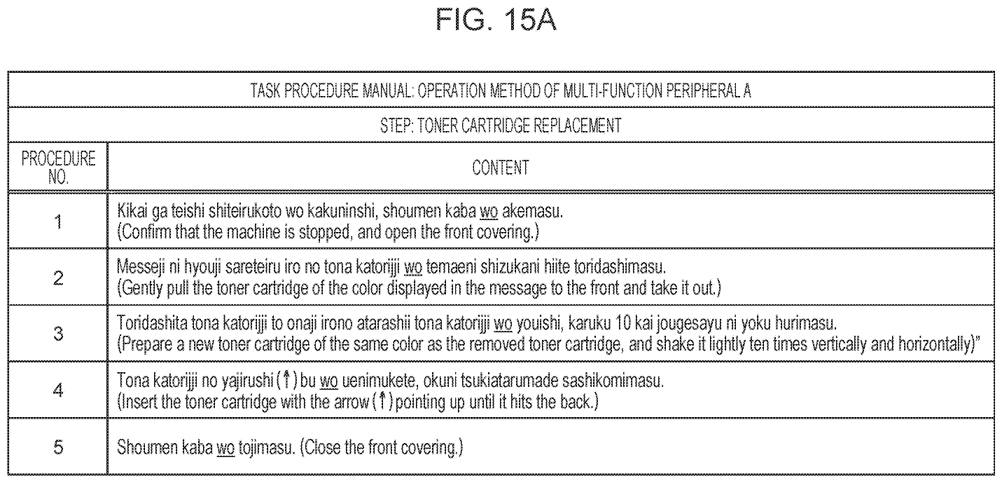

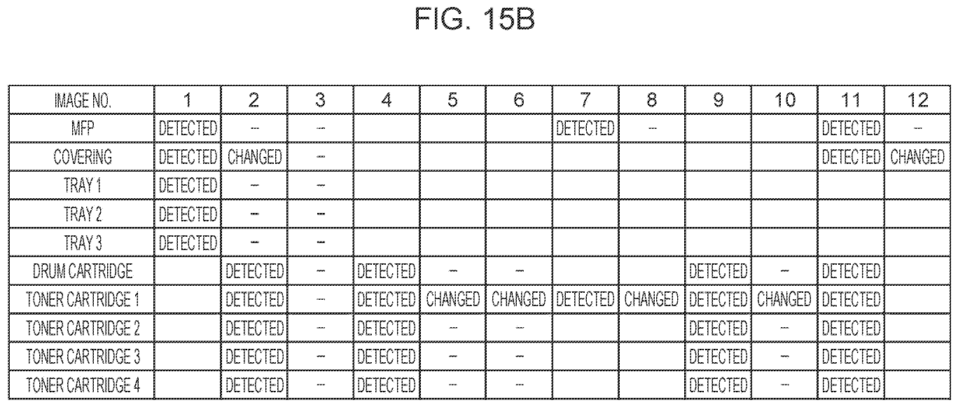

When identifying the timing of the task, the correlation unit 105 specifies the timing of the task based on text data indicating the content of the task, which is included in the task procedure information. Specifically, the correlation unit 105 specifies the timing of the task based on the character string immediately following a character string indicating the target object, included in text data indicating the content of the task. Note that a specific example of a method of identifying the timing of the task based on text data indicating the content of the task will be described later with reference to FIGS. 15A and 15B.

The determination unit 106 determines the validity of the content detected by the change detector 104. Specifically, the determination unit 106 determines the validity of the content detected by the change detector 104 by comparing the task procedure information and the target object detection list to see if the two are correlated. For example, the determination unit 106 compares the order of changes in the state of the target object, which are specified from the target object detection list, with the order of appearance of the target object included in the content of the task, which is identified from the task procedure information, and determines the validity of the content detected by the change detector 104 based on the result of the comparison. In this case, when comparing the order of changes in the state of the target object with the order of appearance of the target object included in the content of the task, the determination unit 106 performs a comparison based on, for example, the Levenshtein distance, which is a reference indicating how different two character strings are.

The display controller 107 performs control for displaying various types of information on the display 36 of the user terminal 30. Specifically, the display controller 107 transmits control information for displaying various types of information on the user terminal 30 to the user terminal 30 via the later-described transmission controller 108. For example, the display controller 107 transmits control information for displaying a plurality of frame images composing a target image as still images to the user terminal 30 via the transmission controller 108. Alternatively, the display controller 107 transmits control information for reproducing a plurality of frame images composing a target image as a moving image to the user terminal 30 via the transmission controller 108. In this case, the display controller 107 transmits control information for displaying task procedure information, which serves as annotation information to be superimposed on the target image being reproduced, to the user terminal 30.

Additionally, the display controller 107 performs control to display image capturing assist information in an image capturing screen of the user terminal 30 which is capturing an image of a target object. Specifically, the display controller 107 transmits control information for displaying image capturing assist information to the user terminal 30 via the transmission controller 108. The timing to display the image capturing assist information in the image capturing screen of the user terminal 30 which is capturing an image of a target object is determined based on the result of correlating a target object detection list with task procedure information by the above-mentioned correlation unit 105.

Specifically, the correlation unit 105 correlates a change in the state of the target object detected in real time by the user terminal 30 with the pre-stored task procedure information, and the timing to display the image capturing assist information is determined based on this correlation. More specifically, the timing to display the image capturing assist information is determined based on the correlation between the timing of the change in the state of the target object, which is identified from the target object detection list, and the timing of the task, which is identified from the task procedure information.

The transmission controller 108 controls the transmission of various types of information. Specifically, the transmission controller 108 controls the transmission of various types of information toward each of the user terminal 30 and the outside. Of the information whose transmission is controlled by the transmission controller 108, examples of information transmitted to the user terminal 30 include control information for displaying a target image and control information for displaying annotation information to be superimposed on the target image.

### User Terminal

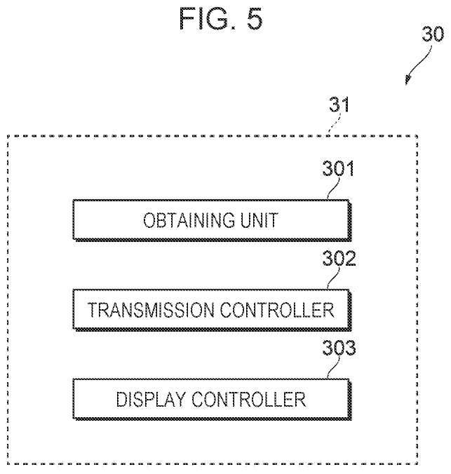

FIG. 5 is a diagram illustrating an example of the functional configuration of the controller 31 of the user terminal 30.

In the controller 31 of the user terminal 30, an obtaining unit 301, a transmission controller 302, and a display controller 303 function.

The obtaining unit 301 obtains various types of information. Specifically, the obtaining unit 301 obtains a target image captured by the image capturing unit 37. In addition, the obtaining unit 301 obtains input information whose input is received by the operation unit 35. Moreover, the obtaining unit 301 obtains various types of information transmitted from the management server 10 and the outside. Of the information obtained by the obtaining unit 301, an example of information transmitted from the management server 10 includes control information for displaying various types of information on the display 36.

The transmission controller 302 controls the transmission of various types of information via the communication unit 34 (see FIG. 3). Specifically, the transmission controller 302 controls the transmission of various types of information to the management server 10 and the outside. Of the information whose transmission is controlled by the transmission controller 302, an example of information transmitted to the management server 10 is a target image.

The display controller 303 performs control for displaying various types of information on the display 36 (see FIG. 3). For example, the display controller 303 performs control for displaying a target image that has been or is being captured on the display 36. In addition, the display controller 303 performs control for displaying annotation information to be superimposed on the target image based on the control information obtained. Note that the term “display” here includes displaying a plurality of frame images composing a target image as still images, as well as reproducing the frame images as a moving image. Note that specific examples of information displayed on the display 36 of the user terminal 30 will be described later.

### Flow of Processing

### Flow of Processing in Management Server

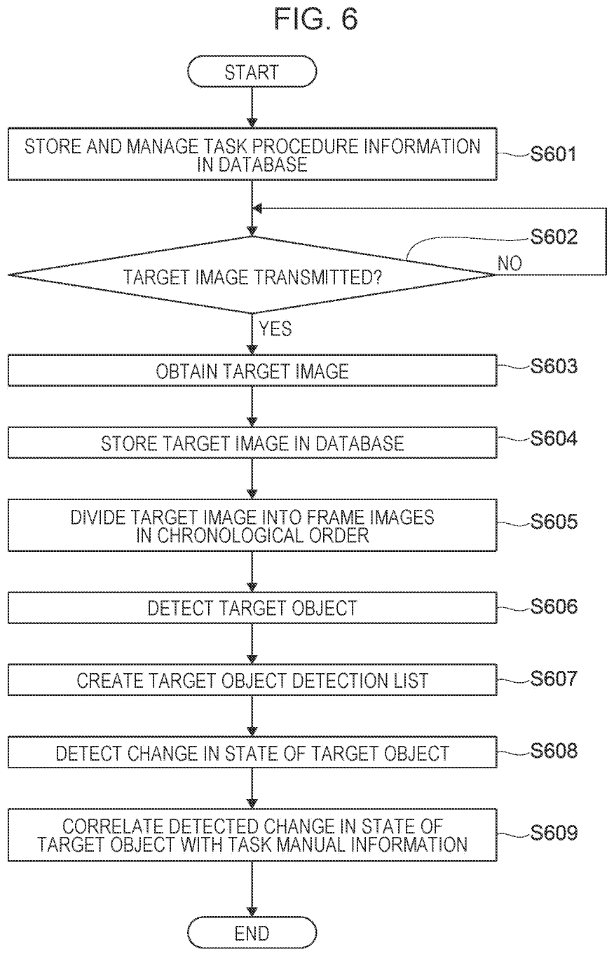

FIG. 6 is a flowchart illustrating an example of the flow of processing in the management server 10.

The management server 10 stores task procedure information in a database and manages it (step S601). Specifically, the management server 10 stores task procedure information in the task procedure DB 131 of the storage 13, and manages it.

When a target image is transmitted from the user terminal 30 to the management server 10 (YES in step S602), the management server 10 obtains the transmitted target image (step S603), and stores the obtained target image in a database (step S604). Specifically, the management server 10 stores the obtained target image in the target image DB 132 of the storage 13, and manages it. In contrast, when no target image has been transmitted (NO in step S602), the management server 10 repeats the determination processing in step S602 until a target image is transmitted.

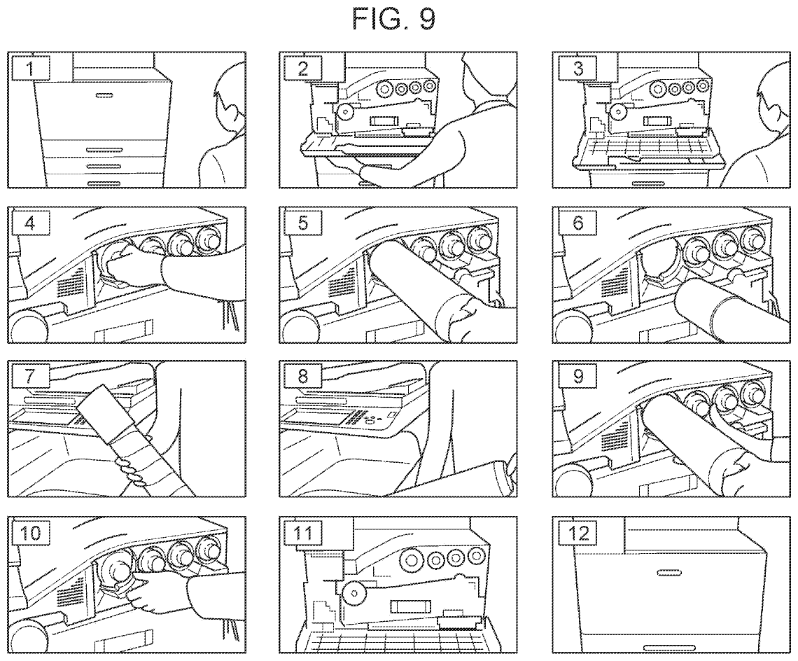

Next, the management server 10 divides the target image obtained in step S603 into a plurality of frame images in chronological order (step S605). Specifically, the management server 10 extracts, from a plurality of frame images composing the target image, frame images corresponding to individual timings (for example, timings 1 to 12 indicated in FIG. 9), and arranges the extracted frame images in chronological order.

Next, the management server 10 detects a target object in each of the frame images indicating the individual timings (step S606), and creates a target object detection list (step S607). The management server 10 then detects a change in the state of the target object based on the generated target object detection list (step S608). Specifically, the management server 10 detects a change in the state of the target object between two timings included in the target object detection list.

Next, the management server 10 correlates the change in the state of the target object detected in step S608 with the task procedure information (step S609). Specifically, the management server 10 correlates the timing of the change in the state of the target object, which is identified from the target object detection list, with the timing of the task, which is identified from the task procedure information.

### Flow of Processing in User Terminal

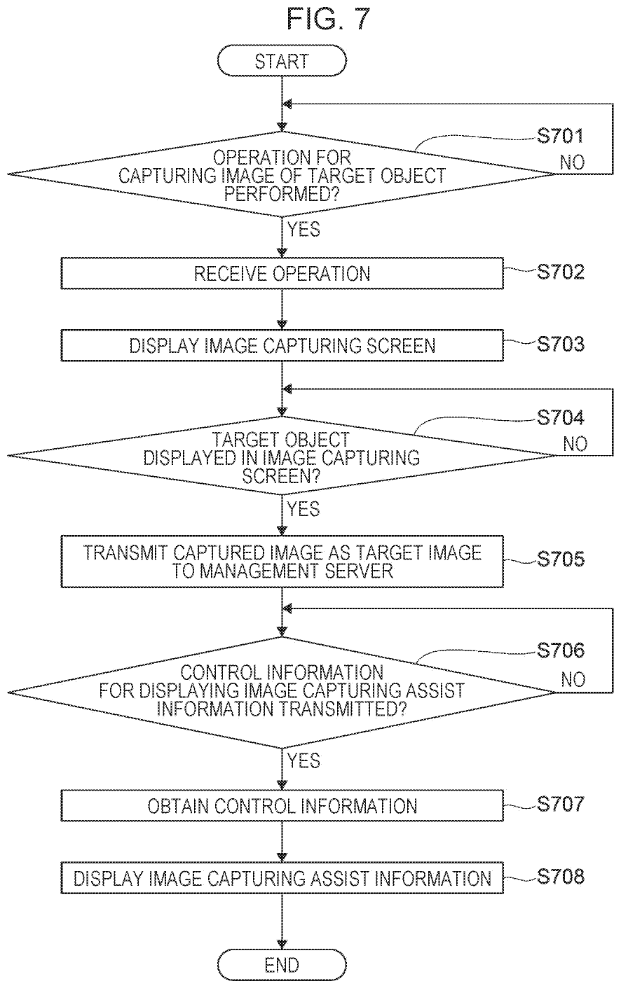

FIG. 7 is a flowchart illustrating an example of the flow of processing executed when capturing an image of a target object, which is part of the processing in the user terminal 30.

When an operation for capturing an image of a target object is performed (YES in step S701), the user terminal 30 receives the operation (step S702), and displays an image capturing screen on the display 36 (step S703). In contrast, when no operation for capturing an image of a target object has been performed (NO in step S701), the user terminal 30 repeats the determination processing in step S701 until an operation for capturing an image of a target object is performed.

Next, when the target object, which serves as the subject, is displayed in the image capturing screen (YES in step S704), the user terminal 30 transmits a captured image thereof as a target image to the management server 10 (step S705). The transmission of the target image from the user terminal 30 to the management server 10 is performed in real time. Then, the management server 10 creates a target object detection list, correlates the target object detection list with the task procedure information, and creates image capturing assist information in sequence. In contrast, when no target subject, which serves as the subject, is displayed in the image capturing screen (NO in step S704), the user terminal 30 repeats the determination processing in step S704 until the target object which serves as the subject is displayed in the image capturing screen.

When control information for displaying the image capturing assist information is transmitted from the management server 10 to the user terminal 30 (YES in step S706), the user terminal 30 obtains the transmitted control information (step S707). The user terminal 30 then displays the image capturing assist information on the display 36 based on the control information obtained in step S707 (step S708). In contrast, when no control information for displaying the image capturing assist information has been transmitted (NO in step S706), the user terminal 30 repeats the determination processing in step S706 until control information for displaying the image capturing assist information is transmitted.

### SPECIFIC EXAMPLES

### Specific Example of Work Procedure Information

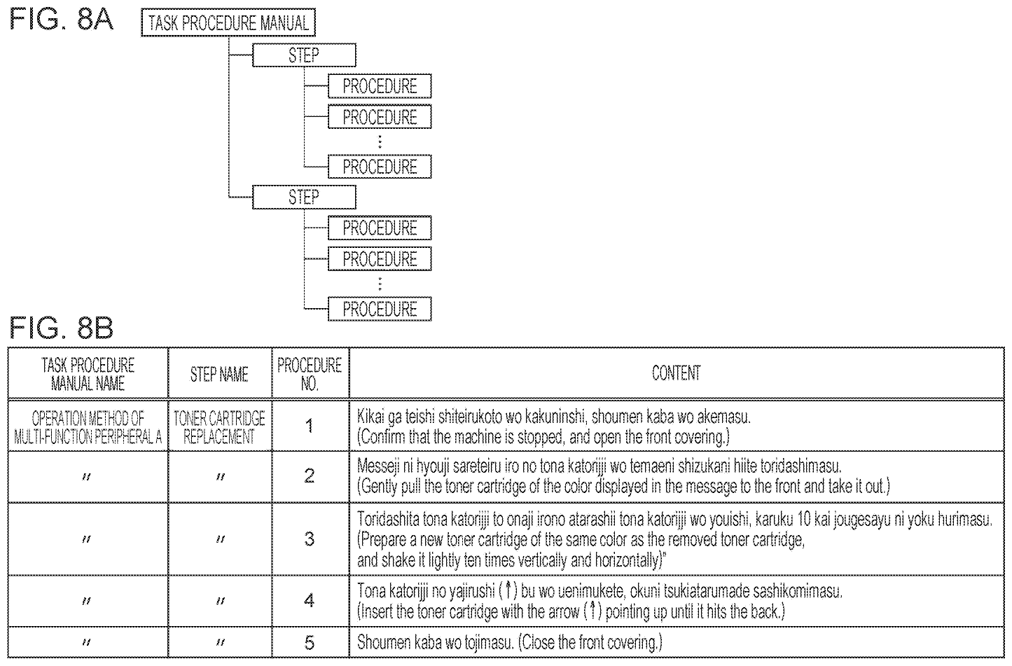

FIGS. 8A and 8B are diagrams illustrating the configuration and content of “Work Procedure Manual” as a specific example of task procedure information. FIG. 8A is a diagram illustrating an example of the configuration of “Work Procedure Manual”. FIG. 8B is a diagram illustrating an example of the content of “Work Procedure Manual”.

As illustrated in FIG. 8A, “Work Procedure Manual” is composed of a plurality of “steps”, and each “step” is composed of a plurality of procedures.

Specifically, “Work Procedure Manual” is composed of the items “task procedure manual name”, “step name”, “procedure No.”, and “content”, as illustrated in FIG. 8B. For example, the task procedure manual name “Operation method of multi-function peripheral A” includes the step name “Toner cartridge replacement”, which has procedure No. “1” with the content “Kikai ga teishi shiteirukoto wo kakuninshi, shoumen kaba wo akemasu. (Confirm that the machine is stopped, and open the front covering)”. The task procedure manual name “Operation method of multi-function peripheral A” includes the step name “Toner cartridge replacement”, which also has procedure No. “2” with the content “Messeji ni hyouji sareteiru iro no tona katorijji wo temaeni shizukani hiite toridashimasu. (Gently pull the toner cartridge of the color displayed in the message to the front and take it out)”. Note that the content of procedures No. “3” to No. “5” is as indicated in FIG. 8B.

FIG. 9 is a diagram illustrating a specific example of a target image.

In FIG. 9, as a target image, twelve frame images composing a moving image for assisting the replacement task of the toner cartridge of a so-called multi-function peripheral are illustrated. These twelve frame images illustrated in FIG. 9 are frame images indicating timings. The numbers “1” to “12” attached to the twelve frame images are numbers attached in chronological order.

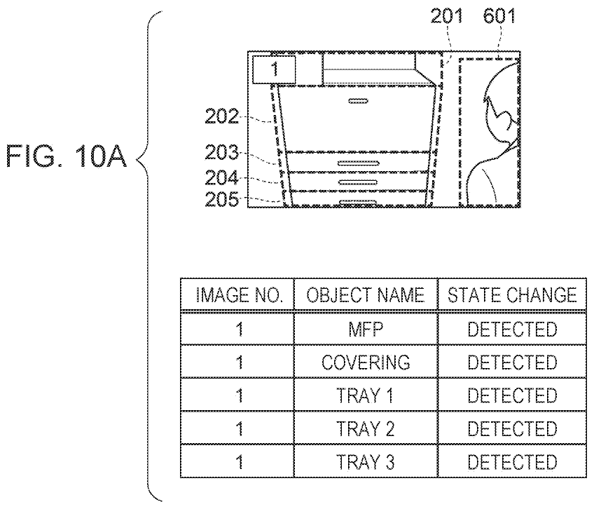

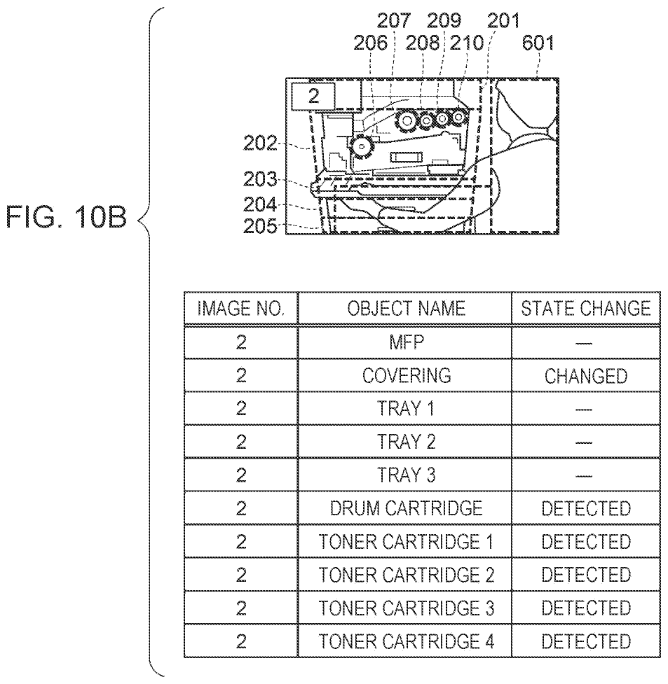

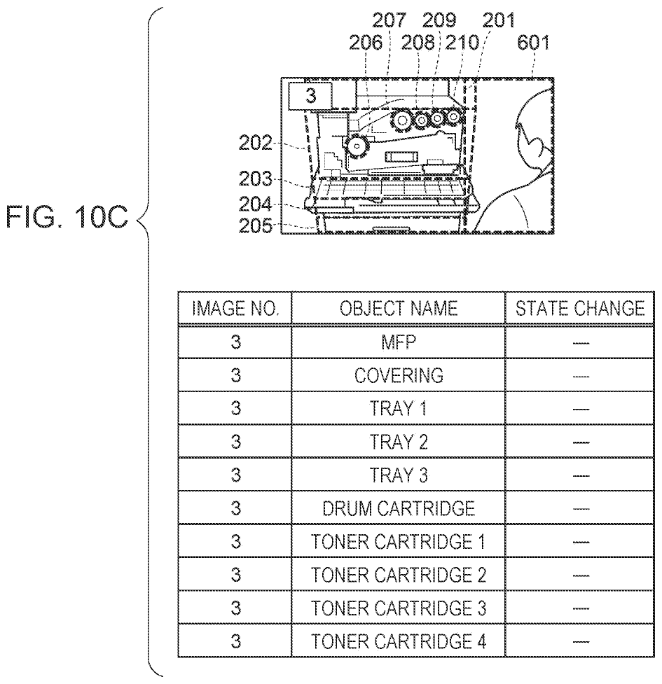

The timing indicated by each of the adjacent frame images is not particularly limited, and, for example, the timing may be a frame image every second. In addition, the frame images may be divided into a plurality of blocks for each scene of the task. For example, as illustrated in FIGS. 10A to 14B described later, the frame images may be divided into a plurality of blocks, namely, “1” to “3” as one scene, “4” to “6” as one scene, “7” and “8” as one scene, “9” and “10” as one scene, and “11” and “12” as one scene.

Hereinafter, the frame images numbered “1” to “12” illustrated in FIG. 9 will be referred to as “image No. 1” to “image No. 12”. Accordingly, the frame image which is “image No. 1” is a frame image indicating the earliest timing of the twelve timings, and the frame image which is “image No. 12” is a frame image indicating the last timing of the twelve timings.

FIGS. 10A to 10C are diagrams illustrating specific examples of, among the frame images which are images No. 1 to No. 12 illustrated in FIG. 9, the frame images which are images No. 1 to No. 3 and target object detection lists corresponding to the frame images. FIG. 10A is a diagram illustrating a specific example of the frame image which is image No. 1 and a target object detection list corresponding to the frame image. FIG. 10B is a diagram illustrating a specific example of the frame image which is image No. 2 and a target object detection list corresponding to the frame image. FIG. 10C is a diagram illustrating a specific example of the frame image which is image No. 3 and a target object detection list corresponding to the frame image.

In each target object detection list, the state of a target object is indicated by one of four types: “detected”, “changed”, “-”, and “blank” (not illustrated). Among these types, “detected” indicates that a target object has been newly detected, and “changed” indicates that a change has occurred in the target object whose state has been detected. In addition, “-” indicates that there is no change in the detected target object, and “blank” indicates that no target object has been detected. That is, in each target object detection list, it is unnecessary to identify an operator's movement (e.g., opening, pulling, pointing up, closing, etc.).

The frame image which is image No. 1 illustrated in FIG. 10A includes a so-called multi-function peripheral as a target object and an operator. A target object detection list corresponding to the frame image includes the items “image No.”, “object name” indicating a target object, and “state change” indicating the content of a change in the state of the target object. The target object detection list illustrated in FIG. 10A indicates that each of the “multi-function peripheral”, “covering”, “tray 1”, “tray 2”, and “tray 3” has been newly “detected” as a state change.

Then, in the frame image which is image No. 1, frame lines 201 to 205 are displayed respectively indicating that the “multi-function peripheral”, “covering”, “tray 1”, “tray 2”, and “tray 3” in the target object detection list have been detected. In addition, in the frame image which is image No. 1, a frame line 601 is displayed indicating that at least a portion of the operator's body has been detected, but this is excluded from the target object detection list.

The frame image which is image No. 2 illustrated in FIG. 10B includes the so-called multi-function peripheral as a target object and the operator. In addition, in the target object detection list illustrated in FIG. 10B, it is indicated that the state of each of the “multi-function peripheral”, “tray 1”, “tray 2”, and “tray 3” is “-” and has not changed, and the state of the “covering” has changed. It is also indicated that each of a “drum cartridge”, “toner cartridge 1”, “toner cartridge 2”, “toner cartridge 3”, and “toner cartridge 4” has been newly “detected” as a state change.

That is, in the target object detection list illustrated in FIG. 10B, it is indicated that, in the comparison between the frame image which is image No. 1 described above and the frame image which is image No. 2, among the target objects, the state of the “covering” has “changed”, and the “multi-function peripheral”, “tray 1”, “tray 2”, and “tray 3” have not changed. Furthermore, because the “covering” has “changed”, it is indicated that the “drum cartridge”, “toner cartridge 1”, “toner cartridge 2”, “toner cartridge 3”, and “toner cartridge 4” have been newly “detected” as target objects.

Then, in the frame image which is image No. 2, frame lines 201 to 210 are displayed respectively indicating that the “multi-function peripheral”, “covering”, “tray 1”, “tray 2”, “tray 3”, “drum cartridge”, “toner cartridge 1”, “toner cartridge 2”, “toner cartridge 3”, and “toner cartridge 4” in the target object detection list have been detected. In addition, in the frame image which is image No. 2, the frame line 601 is displayed indicating that at least a portion of the operator's body has been detected, but this is excluded from the target object detection list.

The frame image which is image No. 3 illustrated in FIG. 10C includes the so-called multi-function peripheral as a target object and the operator. In addition, in the target object detection list illustrated in FIG. 10C, it is indicated that the state of each of the “multi-function peripheral”, “covering”, “tray 1”, “tray 2”, “tray 3”, “drum cartridge”, “toner cartridge 1”, “toner cartridge 2”, “toner cartridge 3”, and “toner cartridge 4” is “-” and has not changed.

That is, in the target object detection list illustrated in FIG. 10C, it is indicated that, in the comparison between the frame image which is image No. 2 described above and the frame image which is image No. 3, among the target objects, the state of the “multi-function peripheral”, “covering”, “tray 1”, “tray 2”, “tray 3”, “drum cartridge”, “toner cartridge 1”, “toner cartridge 2”, “toner cartridge 3”, and “toner cartridge 4” has not changed.

Then, in the frame image which is image No. 3, the frame lines 201 to 210 are displayed respectively indicating that the “multi-function peripheral”, “covering”, “tray 1”, “tray 2”, “tray 3”, “drum cartridge”, “toner cartridge 1”, “toner cartridge 2”, “toner cartridge 3”, and “toner cartridge 4” in the target object detection list have been detected. In addition, in the frame image which is image No. 3, the frame line 601 is displayed indicating that at least a portion of the operator's body has been detected, but this is excluded from the target object detection list.

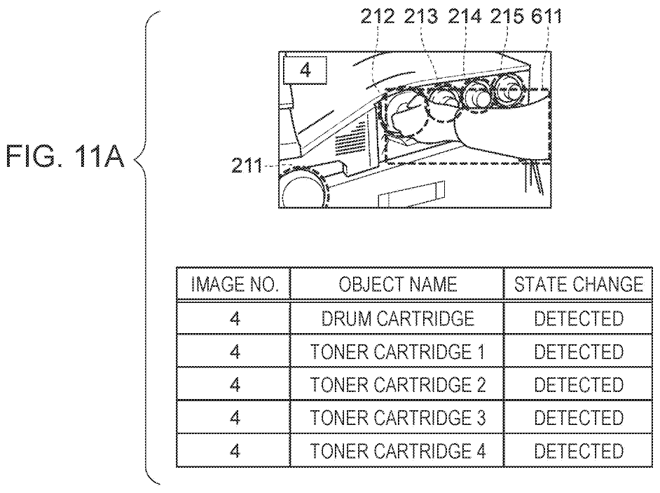

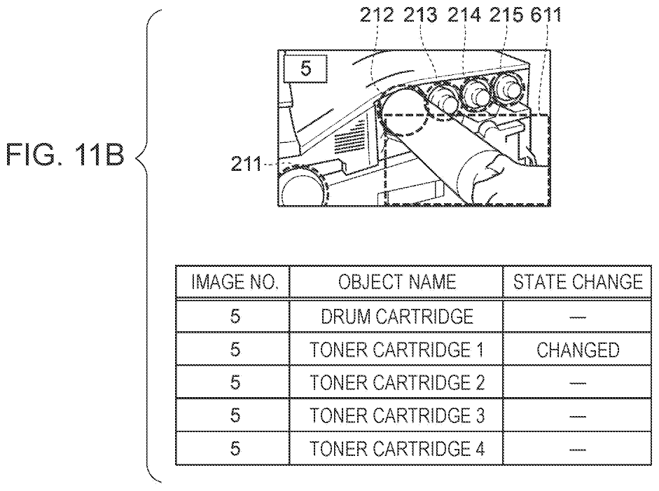

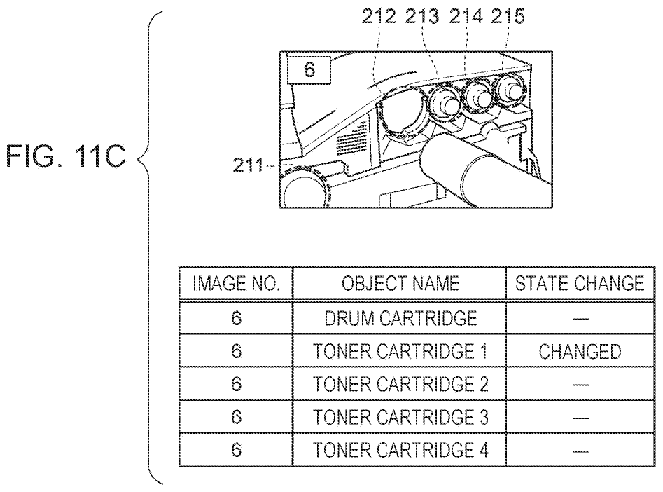

FIGS. 11A to 11C are diagrams illustrating specific examples of, among the frame images which are images No. 1 to No. 12 illustrated in FIG. 9, the frame images which are images No. 4 to No. 6 and target object detection lists corresponding to the frame images. FIG. 11A is a diagram illustrating a specific example of the frame image which is image No. 4 and a target object detection list corresponding to the frame image. FIG. 11B is a diagram illustrating a specific example of the frame image which is image No. 5 and a target object detection list corresponding to the frame image. FIG. 11C is a diagram illustrating a specific example of the frame image which is image No. 6 and a target object detection list corresponding to the frame image.

The frame image which is image No. 4 illustrated in FIG. 11A includes the so-called multi-function peripheral as a target object and the operator. In addition, in the target object detection list corresponding to the frame image, it is indicated that each of the “drum cartridge”, “toner cartridge 1”, “toner cartridge 2”, “toner cartridge 3”, and “toner cartridge 4” has been newly “detected” as a state change.

Then, in the frame image which is image No. 4, frame lines 211 to 215 are displayed respectively indicating that the “drum cartridge”, “toner cartridge 1”, “toner cartridge 2”, “toner cartridge 3”, and “toner cartridge 4” in the target object detection list have been detected. In addition, in the frame image which is image No. 4, a frame line 611 is displayed indicating that at least a portion of the operator's body has been detected, but this is excluded from the target object detection list.

The frame image which is image No. 5 illustrated in FIG. 11B includes the so-called multi-function peripheral as a target object and the operator. That is, in the target object detection list illustrated in FIG. 11B, it is indicated that the state of each of the “drum cartridge”, “toner cartridge 2”, “toner cartridge 3”, and “toner cartridge 4” is “-” and has not changed, and the state of the “toner cartridge 1” has “changed”.

That is, in the target object detection list illustrated in FIG. 11B, it is indicated that, in the comparison between the frame image which is image No. 4 described above and the frame image which is image No. 5, among the target objects, the state of the “toner cartridge 1” has “changed”, and the “drum cartridge”, “toner cartridge 2”. “toner cartridge 3”, and “toner cartridge 4” have not changed.

Then, in the frame image which is image No. 5, the frame lines 211 to 215 are displayed respectively indicating that the “drum cartridge”, “toner cartridge 1”, “toner cartridge 2”, “toner cartridge 3”, and “toner cartridge 4” in the target object detection list have been detected. In addition, in the frame image which is image No. 5, the frame line 611 is displayed indicating that at least a portion of the operator's body has been detected, but this is excluded from the target object detection list.

The frame image which is image No. 6 illustrated in FIG. 11C includes the so-called multi-function peripheral as a target object. In addition, in the target object detection list illustrated in FIG. 11C, it is indicated that the state of each of the “drum cartridge”, “toner cartridge 2”, “toner cartridge 3”, and “toner cartridge 4” is “-” and has not changed, and the state of the “toner cartridge 1” has “changed”.

That is, in the target object detection list illustrated in FIG. 11C, it is indicated that, in the comparison between the frame image which is image No. 5 described above and the frame image which is image No. 6, among the target objects, the state of the “toner cartridge 1” has “changed”, and the “drum cartridge”, “toner cartridge 2”, “toner cartridge 3”, and “toner cartridge 4” have not changed.

Here, the state of the “toner cartridge 1” is “changed” in the target object detection list illustrated in FIG. 11B, and is also “changed” in the target object detection list illustrated in FIG. 11C. In such a case, it is regarded that a series of tasks are performed on the “toner cartridge 1”. That is, in the case where a change in the state of a target object is detected, a plurality of changes in the state that are detected until a change in the state of the target object is no longer detected or until the target object itself is no longer detected are treated as a series of changes in the state of the target object.

Then, in the frame image which is image No. 6, the frame lines 211 to 215 are displayed respectively indicating that the “drum cartridge”, “toner cartridge 1”, “toner cartridge 2”, “toner cartridge 3”, and “toner cartridge 4” in the target object detection list have been detected.

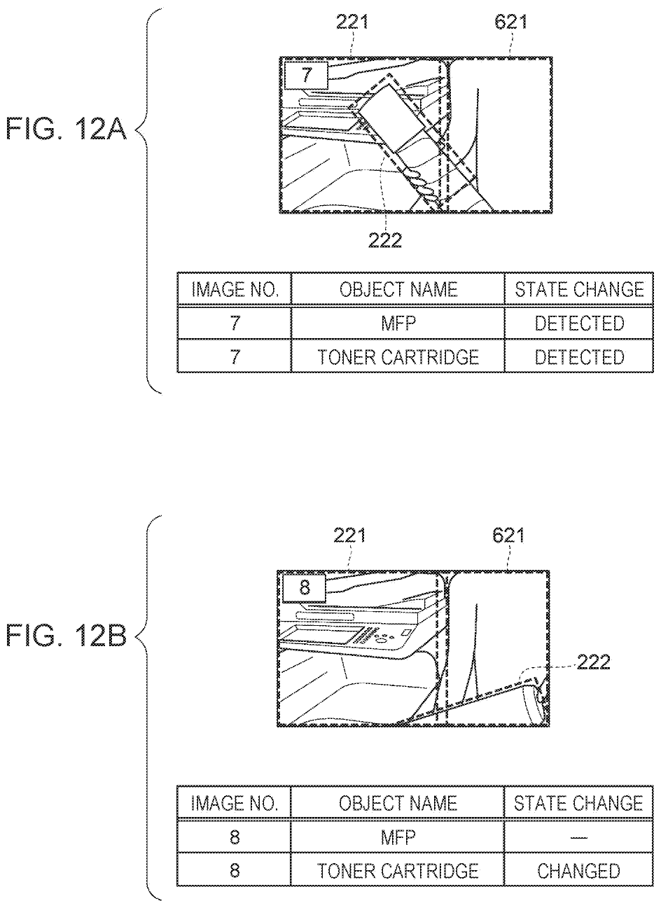

FIGS. 12A and 12B are diagrams illustrating specific examples of, among the frame images which are images No. 1 to No. 12 illustrated in FIG. 9, the frame images which are images No. 7 and No. 8 and target object detection lists corresponding to the frame images. FIG. 12A is a diagram illustrating a specific example of the frame image which is image No. 7 and a target object detection list corresponding to the frame image. FIG. 12B is a diagram illustrating a specific example of the frame image which is image No. 8 and a target object detection list corresponding to the frame image.

The frame image which is image No. 7 illustrated in FIG. 12A includes the so-called multi-function peripheral as a target object and the operator. In addition, in the target object detection list corresponding to the frame image, it is indicated that each of the “multi-function peripheral” and “toner cartridge” has been newly “detected” as a state change.

Then, in the frame image which is image No. 7, frame lines 221 and 222 are displayed respectively indicating that the “multi-function peripheral” and “toner cartridge” in the target object detection list have been detected. In addition, in the frame image which is image No. 7, a frame line 621 is displayed indicating that at least a portion of the operator's body has been detected, but this is excluded from the target object detection list.

The frame image which is image No. 8 illustrated in FIG. 12B includes the so-called multi-function peripheral as a target object and the operator. In addition, in the target object detection list illustrated in FIG. 12B, it is indicated that the state of the “multi-function peripheral” is “-” and has not changed, and the state of the “toner cartridge” has “changed”.

That is, in the target object detection list illustrated in FIG. 12B, it is indicated that, in the comparison between the frame image which is image No. 7 and the frame image which is image No. 8 described above, among the target objects, the state of the “toner cartridge” has “changed”, and the “multi-function peripheral” has not changed.

Then, in the frame image which is image No. 8, the frame lines 221 and 222 are displayed respectively indicating that the “multi-function peripheral” and “toner cartridge” in the target object detection list have been detected. In addition, in the frame image which is image No. 8, the frame line 621 is displayed indicating that at least a portion of the operator's body has been detected, but this is excluded from the target object detection list.

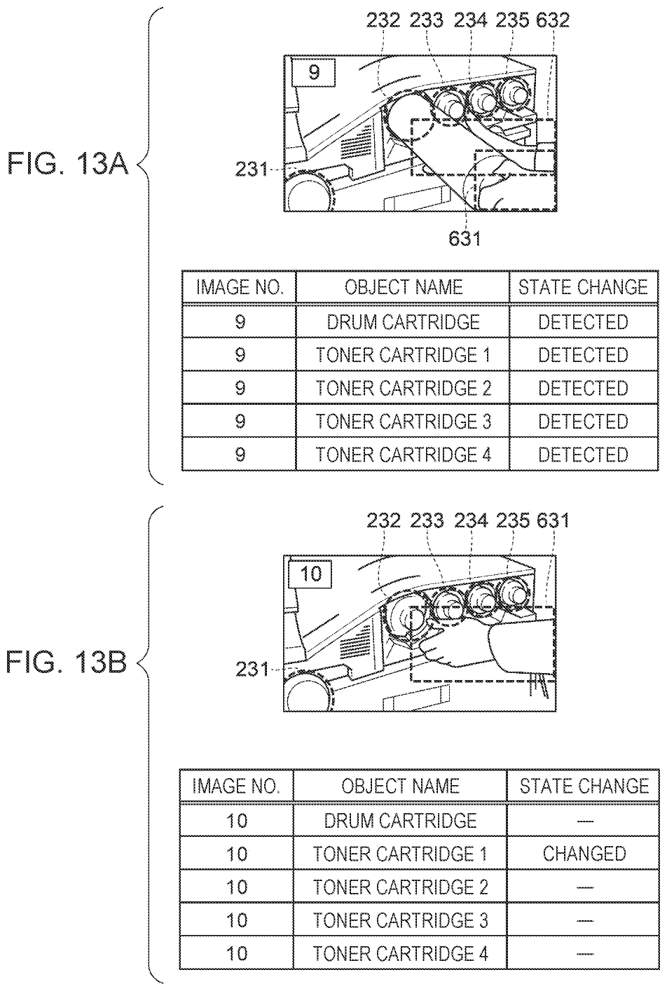

FIGS. 13A and 13B are diagrams illustrating specific examples of, among the frame images which are images No. 1 to No. 12 illustrated in FIG. 9, the frame images which are images No. 9 and No. 10 and target object detection lists corresponding to the frame images. FIG. 13A is a diagram illustrating a specific example the frame image which is image No. 9 and a target object detection list corresponding to the frame image. FIG. 13B is a diagram illustrating a specific example the frame image which is image No. 10 and a target object detection list corresponding to the frame image.

The frame image which is image No. 9 illustrated in FIG. 13A includes the so-called multi-function peripheral as a target object and the operator. In addition, in the target object detection list corresponding to the frame image, it is indicated that each of the “drum cartridge”, “toner cartridge 1”, “toner cartridge 2”, “toner cartridge 3”, and “toner cartridge 4” has been newly “detected” as a state change.

Then, in the frame image which is image No. 9, frame lines 231 to 235 are displayed respectively indicating that the “drum cartridge”, “toner cartridge 1”, “toner cartridge 2”, “toner cartridge 3”, and “toner cartridge 4” in the target object detection list have been detected. In addition, in the frame image which is image No. 9, frame lines 631 and 632 are displayed indicating that at least a portion of the operator's body has been detected, but this is excluded from the target object detection list.

The frame image which is image No. 10 illustrated in FIG. 13B includes the so-called multi-function peripheral as a target object and the operator. In addition, in the target object detection list illustrated in FIG. 13B, it is indicated that each of the “drum cartridge”, “toner cartridge 2”, “toner cartridge 3”, and “toner cartridge 4” is “-” and has not changed, and the state of the “toner cartridge 1” has “changed”.

That is, in the target object detection list illustrated in FIG. 13B, it is indicated that, in the comparison between the frame image which is image No. 9 described above and the frame image which is image No. 10, among the target objects, the state of the “toner cartridge 1” has “changed”, and the “drum cartridge”, “toner cartridge 2”, “toner cartridge 3”, and “toner cartridge 4” have not changed.

Then, in the frame image which is image No. 10, the frame lines 231 to 235 are displayed respectively indicating that the “drum cartridge”, “toner cartridge 1”, “toner cartridge 2”, “toner cartridge 3”, and “toner cartridge 4” in the target object detection list have been detected. In addition, in the frame image which is image No. 10, the frame line 631 is displayed indicating that at least a portion of the operator's body has been detected, but this is excluded from the target object detection list.

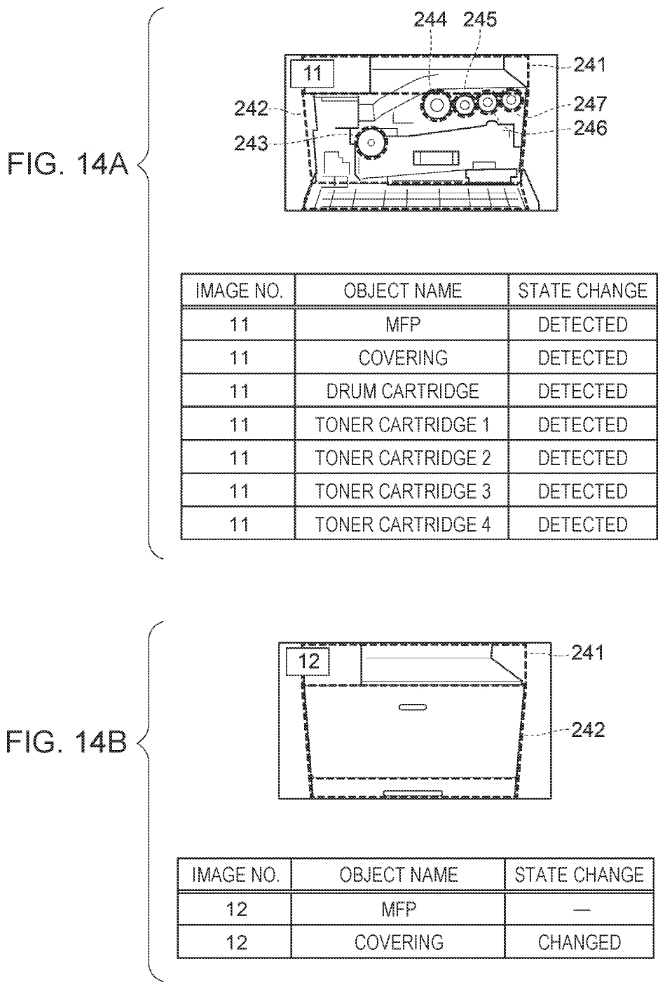

FIGS. 14A and 14B are diagrams illustrating specific examples of, among the frame images which are images No. 1 to No. 12 illustrated in FIG. 9, the frame images which are images No. 11 and No. 12 and target object detection lists corresponding to the frame images. FIG. 14A is a diagram illustrating a specific example of the frame image which is image No. 11 and a target object detection list corresponding to the frame image. FIG. 14B is a diagram illustrating a specific example of the frame image which is image No. 12 and a target object detection list corresponding to the frame image.

The frame image which is image No. 11 illustrated in FIG. 14A includes the so-called multi-function peripheral as a target object and the operator. In addition, in the target object detection list corresponding to the frame image, it is indicated that each of the “multi-function peripheral”, “covering”, “drum cartridge”, “toner cartridge 1”, “toner cartridge 2”, “toner cartridge 3”, and “toner cartridge 4” has been newly “detected” as a state change.

Then, in the frame image which is image No. 11, frame lines 241 to 247 are displayed respectively indicating that the “multi-function peripheral”, “covering”, “drum cartridge”, “toner cartridge 1”, “toner cartridge 2”, “toner cartridge 3”, and “toner cartridge 4” in the target object detection list have been detected.

The frame image which is image No. 12 illustrated in FIG. 14B includes the so-called multi-function peripheral as a target object and the operator. In addition, in the target object detection list illustrated in FIG. 14B, it is indicated that the state of the “multi-function peripheral” is “-” and has not changed, and the state of the “covering” has “changed”.

That is, in the target object detection list illustrated in FIG. 14B, it is indicated that, in the comparison between the frame image which is image No. 11 described above and the frame image which is image No. 12, among the target objects, the state of the “covering” has “changed”, and the “multi-function peripheral” has not changed. Then, in the frame image which is image No. 12, the frame lines 241 and 242 are displayed respectively indicating that the “multi-function peripheral” and “covering” in the target object detection list have been detected.

FIGS. 15A and 15B are diagrams illustrating a specific example of a process of correlating a target object detection list with task procedure information. FIG. 15A is a diagram illustrating a specific example of the content of “Work Procedure Manual” as task procedure information. FIG. 15B is a diagram illustrating a specific example of a target object detection list.

When correlating a change in the state of a target object with task procedure information, the management server 10 correlates the timing of the change in the state of the target object, which is identified from a target object detection list, with the timing of the task, which is identified from the task procedure manual. The timing of the task is identified based on the character string immediately following a character string indicating the target object, included in text data indicating the content of the task of the task procedure manual. Specifically, in the case where the target object is the direct object based on the character string immediately following a character string indicating the target object, the procedure is identified as the timing at which some sort of task has been performed on the target object.

For example, text data indicating the content of procedure No. “1” of the task procedure manual illustrated in FIG. 15A is “Kikai ga teishi shiteirukoto wo kakuninshi, shoumen kaba wo akemasu. (Confirm that the machine is stopped, and open the front covering)”. In this text data, the target object is “kaba (covering)”, and the character string immediately following a character string indicating the target object, is “wo” which is underlined. In this case, because “covering” is the direct object, procedure No. “1” is identified as the timing at which some sort of task is performed on the “covering”. In contrast, in image No. 2 in the target object detection list, the state of the target object “covering” is “changed”. Therefore, image No. 2 in the target object detection list is correlated with procedure No. “1” in the task procedure manual.

Moreover, text data indicating the content of procedure No. 2 of the task procedure manual is “Messeji ni hyouji sareteiru iro no tona katorijji wo temaeni shizukani hiite toridashimasu. (Gently pull the toner cartridge of the color displayed in the message to the front and take it out)”. In this text data, the target object is “tona katorijji (toner cartridge)”, and the character string immediately following a character string indicating the target object, is “wo” which is underlined. In this case, because the “toner cartridge” is the direct object, procedure No. “2” is identified as the timing at which some sort of task is performed on the “toner cartridge”. In the meanwhile, the state of the target object “toner cartridge” has continuously “changed” in images No. 5 and No. 6 in the target object detection list. In such a case, it is regarded that a series of tasks are performed on the “toner cartridge 1”, and images No. 5 and No. 6 in the target object detection list are correlated with procedure No. “2” of the task procedure manual.

In addition, text data indicating the content of procedure No. “3” of the task procedure manual is “Toridashita tona katorijji to onaji irono atarashii tona katorijji wo youishi, karuku 10 kai jougesayu ni yoku hurimasu. (Prepare a new toner cartridge of the same color as the removed toner cartridge, and shake it lightly ten times vertically and horizontally)”. In this text data, the target object is “tona katorijji (toner cartridge)”, and the character string immediately following a character string indicating the target object, is “wo” which is underlined. In this case, because the “toner cartridge” is the direct object, procedure No. “3” is identified as the timing at which some sort of task is performed on the “toner cartridge”. In the meanwhile, the state of the target object “toner cartridge 1” has “changed” in image No. 8 in the target object detection list. Therefore, image No. 8 in the target object detection list is correlated with procedure No. “3” of the task procedure manual.

Similarly, procedure No. “4” is also specified as the timing at which some sort of task is performed on the “toner cartridge”. In the meanwhile, the state of the target object “toner cartridge” has “changed” in image No. 10 in the target object detection list. Therefore, image No. 10 in the target object detection list is correlated with procedure No. “4” of the task procedure manual. In addition, like procedure No. “1” described above, procedure No. “5” is identified as the timing at which some sort of task is performed on the “covering”. In the meanwhile, the state of the target object “covering” has “changed” in image No. 12 in the target object detection list. Therefore, image No. 12 in the target object detection list is correlated with procedure No. “5” of the task procedure manual.

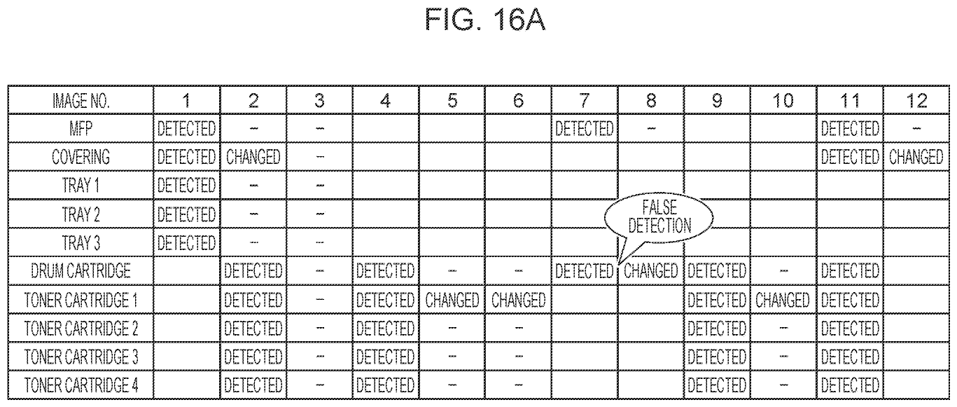

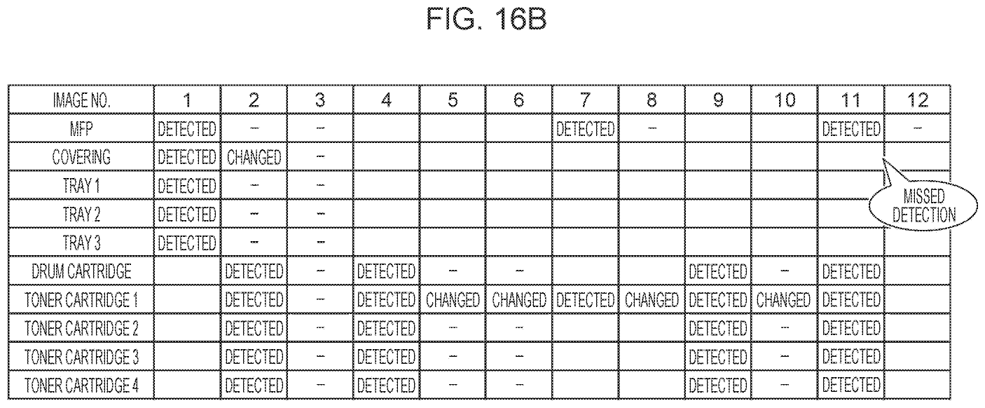

FIG. 16 is a diagram illustrating a specific example of a process of determining the validity of detection.

In the present exemplary embodiment, the order of changes in the state of target objects, which is identified from a target object detection list, and the order of appearance of target objects included in the content of the task, which is identified from a task procedure manual, are compared, and the validity of the detected content is determined based on the result of the comparison. In the comparison, a comparison is done based on the Levenshtein distance, which is a reference indicating how different two character strings are.

For example, the target object detection list illustrated in FIG. 15B described above indicates the case in which detection has been correctly performed. Therefore, the Levenshtein distance is “zero”. Specifically, target objects whose state has “changed” in the target object detection list, which are arranged in the order of “image No.”, are compared with target objects whose state has been determined to have changed in the task procedure manual, which are arranged in the order of “procedure No.”. Then, the target object detection list takes the order “covering” (image No. 2), “toner cartridge 1” (images No. 5 and No. 6), “toner cartridge 1” (image No. 8), “toner cartridge 1” (image No. 10), and “covering” (image No. 12). In the meanwhile, the task procedure manual illustrated in FIG. 15A described above takes the order “covering” (procedure No. 1), “toner cartridge” (procedure No. 2), “toner cartridge” (procedure No. 3), “toner cartridge” (procedure No. 4), and “covering” (procedure No. 5), which is the same as the order in the target object detection list. Therefore, the Levenshtein distance is “zero”.

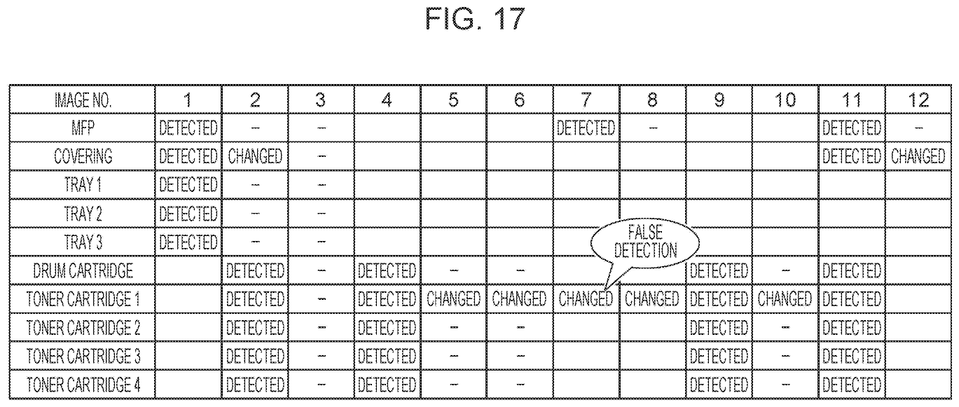

In contrast, for example, as illustrated in FIGS. 16A, 16B, and 17, detection may not have been correctly performed. Examples of the case in which detection has not been correctly performed includes false detection, missed detection, etc.

FIG. 16A is a diagram illustrating a specific example of false detection of a target object.

In image No. “7” in the target object detection list illustrated in FIG. 15B described above, it is indicated that the target object “toner cartridge 1” has been “detected”; and, in image No. “8”, it is indicated that the target object “toner cartridge 1” has “changed”. In the meanwhile, in image No. “7” in the target object detection list illustrated in FIG. 16A, it is indicated that the target object “drum cartridge” has been “detected”; and, in image No. “8”, it is indicated that the target object “drum cartridge” has “changed”. That is, in image No. “7” in the target object detection list illustrated in FIG. 16A, the target object supposed to be detected is the “toner cartridge 1”, but is detected as the “drum cartridge”, resulting in false detection of the target object. In this case, the Levenshtein distance is “one”.

Specifically, the target object detection list illustrated in FIG. 16A takes the order “covering” (image No. 2), “toner cartridge 1” (images No. 5 and No. 6), “drum cartridge” (image No. 8), “toner cartridge 1” (image No. 10), and “covering” (image No. 12). In the meanwhile, the task procedure manual illustrated in FIG. 15A described above takes the order “covering” (procedure No. 1), “toner cartridge” (procedure No. 2), “toner cartridge” (procedure No. 3), “toner cartridge” (procedure No. 4), and “covering” (procedure No. 5), in which “procedure No. 3” is different. Therefore, the Levenshtein distance is “one”.

FIG. 16B is a diagram illustrating a specific example of missed detection of a target object.

In image No. “11” in the target object detection list illustrated in FIG. 15B described above, it is indicated that the target object “covering” has been “detected”; and, in image No. “12”, it is indicated that the target object “covering” has “changed”. In the meanwhile, in images No. “11” and No. “12” in the target object detection list illustrated in FIG. 16B, nothing is recorded for the target object “covering”. That is, missed detection of the target object “covering” is occurring in image No. “11” in the target object detection list illustrated in FIG. 16B. In this case, the Levenshtein distance is “one”.

Specifically, the target object detection list illustrated in FIG. 16B takes the order “covering” (image No. 2), “toner cartridge 1” (images No. 5 and No. 6), “toner cartridge 1” (image No. 8), and “toner cartridge 1” (image No. 10). In the meanwhile, the task procedure manual illustrated in FIG. 15A described above takes the order “covering” (procedure No. 1), “toner cartridge 1” (procedure No. 2), “toner cartridge” (procedure No. 3), “toner cartridge” (procedure No. 4), and “covering” (procedure No. 5), which is one greater than the target object detection list. Therefore, the Levenshtein distance is “one”.

FIG. 17 is a diagram illustrating a specific example of false detection of a change in the state of a target object.

In image No. “7” in the target object detection list illustrated in FIG. 15B described above, it is indicated that the target object “toner cartridge 1” has been “detected”. In the meanwhile, in image No. “7” in the target object detection list illustrated in FIG. 17, it is indicated that the target object “toner cartridge 1” has “changed”. That is, in image No. 7 of the target object detection list illustrated in FIG. 17, because the state change of the target object “toner cartridge 1” supposed to be detected as “detected” is detected as “changed”, false detection of the state change has occurred. In this case, the Levenshtein distance is “one”.

Specifically, the target object detection list illustrated in FIG. 17 takes the order “covering” (image No. 2), “toner cartridge 1” (images No. 5 and No. 6), “toner cartridge 1” (image No. 7), “toner cartridge 1” (image No. 8), “toner cartridge 1” (image No. 10), and “covering” (image No. 12). In the meanwhile, the task procedure manual illustrated in FIG. 15A described above takes the order “covering” (procedure No. 1), “toner cartridge 1” (procedure No. 2), “toner cartridge” (procedure No. 3), “toner cartridge” (procedure No. 4), and “covering” (procedure No. 5), which is one less than the target object detection list. Therefore, the Levenshtein distance is “one”.

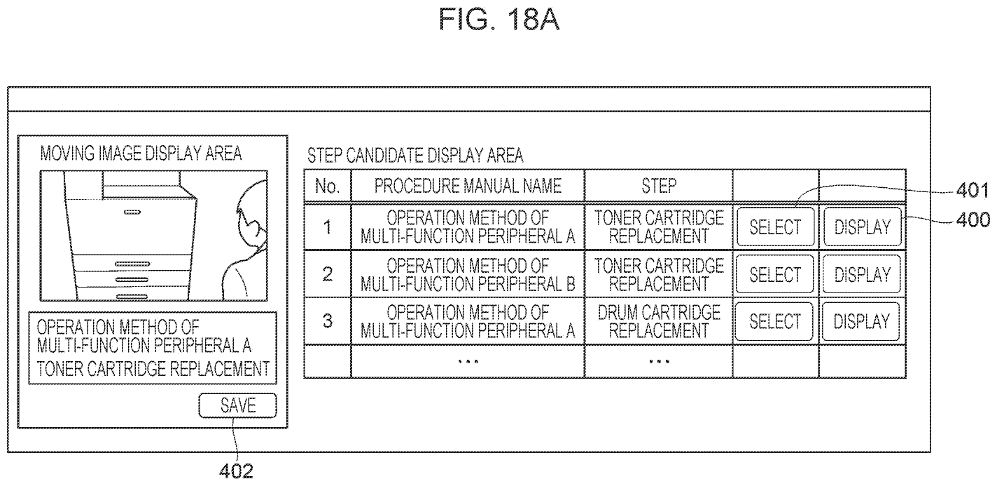

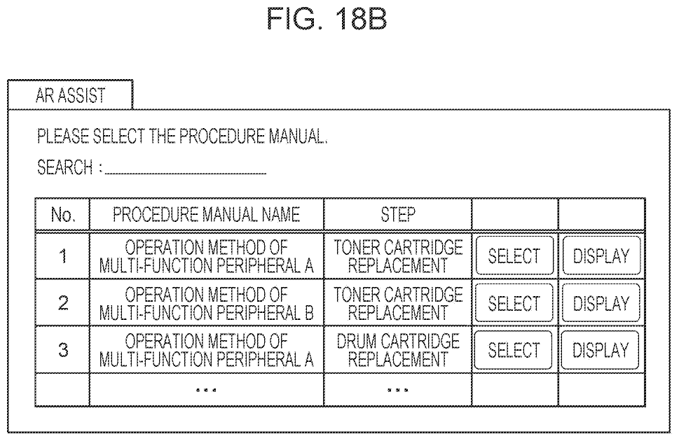

FIG. 18A is a diagram illustrating a specific example of a user interface used for operation to modify a target object detection list.

By displaying an operation screen illustrated in FIG. 18A while a target image is being reproduced, it is possible to correlate the target image with a task procedure manual. Specifically, when a target image is reproduced, task procedure manuals and their steps are displayed in ascending order of the Levenshtein distance. Here, when a button 400 labeled “display” is pressed, the task procedure manual illustrated in FIG. 15A described above is displayed. Next, when a button 401 labeled “select” is pressed, the target image is correlated with a step of the task procedure manual. Lastly, when a button 402 labeled “save” is pressed, the correlation is saved.

FIG. 18B is a diagram illustrating a specific example of image capturing assist information displayed in an image capturing screen while capturing an image of a target object.

When the user is capturing an image of a target object, image capturing assist information is displayed superimposed on the image capturing screen. The image capturing assist information is displayed based on the correlation between a change in the state of the target object, detected in real time during the image capturing, and pre-stored task procedure information. Alternatively, a Quick Response (QR) code (registered trademark) or the like, which is predetermined identification information, may be affixed to a target object, and a step of a corresponding task manual may be identified by capturing an image of and reading the QR code at the user terminal 30.

The image capturing assist information is displayed so as to be superimposed on the image capturing screen as a user interface labeled “Augmented Reality (AR) assist”, for example, as illustrated in FIG. 18B. The content of the image capturing assist information is not particularly limited, and, for example, as illustrated in FIG. 18B, a step of a task procedure manual may be selected to be correlated with a target image being captured.

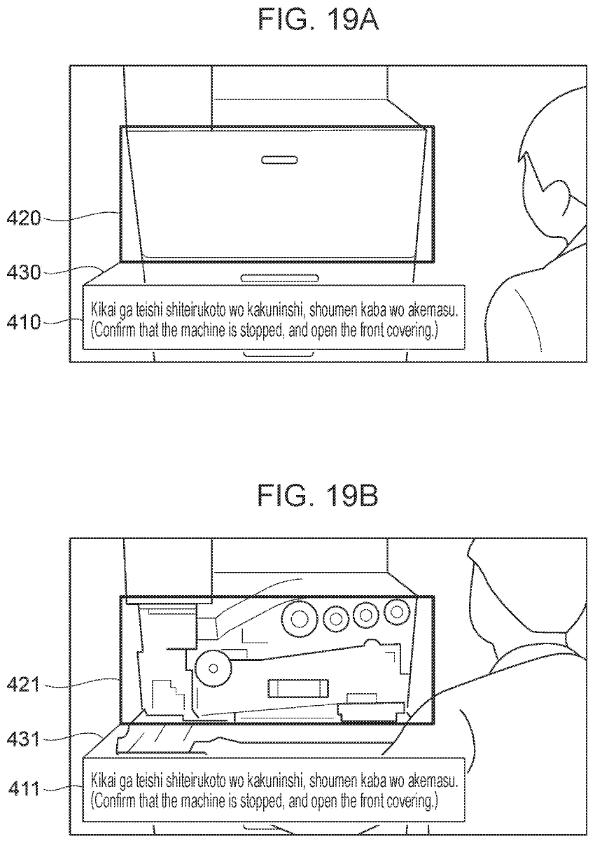

FIGS. 19A and 19B are diagrams illustrating other specific examples of image capturing assist information displayed in the image capturing screen while capturing an image of a target object.

When the user is capturing an image of a target object, as illustrated in FIG. 19A, annotation information 410 indicating a procedure of a step of a task procedure manual selected by the user is displayed superimposed on the image capturing screen. Then, when the detected state change of the target object ends, as illustrated in FIG. 19B, annotation information 411 indicating the next procedure is displayed superimposed on the image capturing screen. Procedures to be displayed are extracted from a target object detection list correlated with the step of the task procedure manual selected by the user. At this time, to make it easier for the user to visually recognize, the annotation information 410 and a frame line 420 may be connected by a line 430 in the example illustrated in FIG. 19A, and the annotation information 411 and a frame line 421 may be connected by a line 431 in the example illustrated in FIG. 19B.

### OTHER EXEMPLARY EMBODIMENTS

Although the present exemplary embodiment has been described thus far, the present disclosure is not limited to the above-described exemplary embodiment. The effects of the present disclosure are not limited to those described in the above-described exemplary embodiment. For example, the configuration of the information processing system 1 illustrated in FIG. 1, the hardware configuration of the management server 10 illustrated in FIG. 2, and the hardware configuration of the user terminal 30 illustrated in FIG. 3 are merely examples for achieving an object of the present disclosure, and are not particularly limited. In addition, the functional configuration of the management server 10 illustrated in FIG. 4 and the functional configuration of the user terminal 30 illustrated in FIG. 5 are merely examples, and are not particularly limited. It is sufficient that the information processing system 1 illustrated FIG. 1 be equipped with functions for performing the above-described processes as a whole, and what kind of functional configuration is used to realize the functions is not limited to the examples illustrated in FIGS. 4 and 5.

Moreover, the order of steps of the processing in the management server 10 illustrated in FIG. 6 and of the processing in the user terminal 30 illustrated in FIG. 7 is merely an example, and is not particularly limited. In addition to the processing performed chronologically along the order of the illustrated steps, the steps may not necessarily be processed chronologically, but may be performed in parallel or individually. In addition, the specific examples illustrated in FIGS. 8A to 19B are merely examples, and are not particularly limited.

For example, although the configuration is such that the management server 10 detects an object and a change in the state of the object in the above-described exemplary embodiment, this is not the only possible configuration. Because it is only necessary that the processes be performed in the information processing system as a whole, the configuration may be such that the processes are performed by the user terminal 30.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An information processing system comprising:
one or more processors configured to:
   from an image captured of a target object of a task and a worker performing the task, detect the target object and a change in a state of the target object; and
   correlate information about the detected change in the state of the target object with information about a pre-created procedure of the task.
      (((2)))
The information processing system according to (((1))), wherein:
the one or more processors are configured to correlate a timing of the change in the state of the target object, which is identified from the information about the change in the state of the target object, with a timing of the task, which is identified from the information about the procedure of the task.
   (((3)))
The information processing system according to (((2))), wherein:
the one or more processors are configured to identify the timing of the task based on text data indicating content of the task, which is included in the information about the procedure of the task.
   (((4)))
The information processing system according to (((3))), wherein:
the one or more processors are configured to identify the timing of the task based on a character string immediately following a character string indicating the target object, which are included in the text data.
   (((5)))
The information processing system according to (((2))), wherein:
the one or more processors are configured to perform control to display the information about the procedure of the task on the image based on correlation between the timing of the change in the state of the target object and the timing of the task.
   (((6)))
The information processing system according to any one of (((1))) to (((5))), wherein:
the one or more processors are configured to, based on correlation between the timing of the change in the state of the target object, which is identified from the information about the change in the state of the target object detected when capturing the image, and the timing of the task, which is identified from the information about the procedure of the task, perform control to display information for assisting capturing the image on a display of an information processing apparatus that is capturing the image.
   (((7)))
The information processing system according to (((6))), wherein:
the one or more processors are configured to perform control to display the information about the procedure of the task as the information for assisting capturing the image on the display of the information processing apparatus.
   (((8)))
The information processing system according to any one of (((1))) to (((7))), wherein:
the one or more processors are configured to detect a change in the state of the target object based on a chronological order of the state of the target object, which is included in each of a plurality of the images.
   (((9)))
The information processing system according to (((8))), wherein:
the one or more processors are configured to, in a case where a change in the state of the target object is detected, treat a plurality of changes in the state that are detected until a change in the state of the target object is no longer detected or until the target object itself is no longer detected as a series of changes in the state of the target object.
   (((10)))
The information processing system according to (((8))), wherein:
the one or more processors are configured to determine validity of detection of target objects and changes in a state of the target objects based on a result of comparing an order of changes in the state of the target objects, which is identified from information about the changes in the state of the target objects, with an order of appearance of the target objects included in the content of the task, which is identified from the information about the procedure of the task.
   (((11)))
The information processing system according to (((10))), wherein:
the one or more processors are configured to compare the order of changes in the state of the target objects with the order of appearance of the target objects based on Levenshtein distance which is a reference indicating how different two character strings are.
   (((12)))
A program causing a computer to realize:
a function of detecting, from an image captured of a target object of a task and a worker performing the task, the target object and a change in a state of the target object; and
a function of correlating information about the detected change in the state of the target object with information about a pre-created procedure of the task.

What is claimed is:

1. An information processing system comprising:
one or more processors configured to:
from an image captured of a target object of a task and a worker performing the task, detect the target object and a change in a state of the target object; and
correlate information about the detected change in the state of the target object with information about a pre-created procedure of the task.

2. The information processing system according to claim 1, wherein:
the one or more processors are configured to correlate a timing of the change in the state of the target object, which is identified from the information about the change in the state of the target object, with a timing of the task, which is identified from the information about the procedure of the task.

3. The information processing system according to claim 2, wherein:
the one or more processors are configured to identify the timing of the task based on text data indicating content of the task, which is included in the information about the procedure of the task.

4. The information processing system according to claim 3, wherein:
the one or more processors are configured to identify the timing of the task based on a character string immediately following a character string indicating the target object, which are included in the text data.

5. The information processing system according to claim 2, wherein:
the one or more processors are configured to perform control to display the information about the procedure of the task on the image based on correlation between the timing of the change in the state of the target object and the timing of the task.

6. The information processing system according to claim 1, wherein:
the one or more processors are configured to, based on correlation between the timing of the change in the state of the target object, which is identified from the information about the change in the state of the target object detected when capturing the image, and the timing of the task, which is identified from the information about the procedure of the task, perform control to display information for assisting capturing the image on a display of an information processing apparatus that is capturing the image.

7. The information processing system according to claim 6, wherein:
the one or more processors are configured to perform control to display the information about the procedure of the task as the information for assisting capturing the image on the display of the information processing apparatus.

8. The information processing system according to claim 1, wherein:
the one or more processors are configured to detect a change in the state of the target object based on a chronological order of the state of the target object, which is included in each of a plurality of the images.

9. The information processing system according to claim 8, wherein:
the one or more processors are configured to, in a case where a change in the state of the target object is detected, treat a plurality of changes in the state that are detected until a change in the state of the target object is no longer detected or until the target object itself is no longer detected as a series of changes in the state of the target object.

10. The information processing system according to claim 1, wherein:
the one or more processors are configured to determine validity of detection of target objects and changes in a state of the target objects based on a result of comparing an order of changes in the state of the target objects, which is identified from information about the changes in the state of the target objects, with an order of appearance of the target objects included in the content of the task, which is identified from the information about the procedure of the task.

11. The information processing system according to claim 10, wherein:
the one or more processors are configured to compare the order of changes in the state of the target objects with the order of appearance of the target objects based on Levenshtein distance which is a reference indicating how different two character strings are.

12. A non-transitory computer readable medium storing a program causing a computer to execute a process, the process comprising:
from an image captured of a target object of a task and a worker performing the task, detecting the target object and a change in a state of the target object; and
correlating information about the detected change in the state of the target object with information about a pre-created procedure of the task.

13. An information processing method comprising:
from an image captured of a target object of a task and a worker performing the task, detecting the target object and a change in a state of the target object; and
correlating information about the detected change in the state of the target object with information about a pre-created procedure of the task.
